(19) United States
(12) Patent Application Publication
(10) Pub. No.: US 2026/0257104 A1
(43) Pub. Date: Sep. 3, 2026

(54) INTELLIGENT MOTION ANALYSIS SYSTEM AND ASSOCIATED PRESSURE SENSING DEVICE

(71) Applicants: VINCENT LEE SMITH II, Edgefield, SC (US); YI-CHUNG SUN, Taipei City (TW); ITRACXING TECHNOLOGY CO., LTD., Taipei City (TW)

(72) Inventors: YI-CHUNG SUN, Taipei City (TW); VINCENT LEE SMITH, II, Edgefield, SC (US)

(21) Appl. No.: 19/260,594

(22) Filed: Jul. 6, 2025

(30) Foreign Application Priority Data
Mar. 3, 2025 (TW) 114202083

(51) Int. Cl. A63B 24/00; A63B 60/46; G01L 1/18; G01L 5/00; G01P 13/00; G01P 15/18; G06T 7/20

(52) U.S. Cl. CPC A63B 24/0003; A63B 60/46; G01L 1/18; G01L 5/0052; G01P 13/00; G01P 15/18; G06T 7/20; A63B 2220/05; A63B 2220/40; A63B 2220/53; A63B 2220/56; A63B 2220/58; A63B 2220/806; A63B 2220/833; A63B 2225/50; G06T 2207/10016; G06T 2207/30221

(57) ABSTRACT

An intelligent motion analysis system includes a pressure sensing device and a computing device is provided. The pressure sensing device includes a wireless module, a pressure sensing part and an accelerometer. The pressure sensing part generates a corresponding pressure sensing signal according to the force. The accelerometer is used to generate an acceleration signal according to the action of the pressure sensing device. The computing device includes a processor, a wireless transceiver module, a memory module and a camera module. The camera module is used to capture a video of the pressure sensing device and its surroundings and transmit the video to the processor. The processor executes the application program to generate an operation result based on the video, the pressure sensing signal and the acceleration signal, and the operation result is used to generate an analysis report for a motion event.

### BACKGROUND OF THE PRESENT INVENTION

### Field of Invention

The present invention relates to the determination of the type of batting a ball in ball sports, and more specifically, to an intelligent motion analysis system and related intelligent motion analysis method.

### Description of Related Arts

With the advancement of neural algorithms, artificial intelligence has been applied to big data analysis in various fields, but there has not been a significant breakthrough in artificial intelligence analysis of ball sports. Therefore, there is a need for a novel system and method to make more accurate analysis of ball sports (such as batting postures and opponent's serve types).

### SUMMARY OF THE PRESENT INVENTION

One of the objectives of the present invention is to provide a novel intelligent motion analysis system and related pressure sensing device and intelligent motion analysis method.

Based on the above objectives, an embodiment of the present application provides an intelligent motion analysis system pressure sensing device comprises a wireless module, a pressure sensing part and an accelerometer. The wireless module is arranged to transmit wireless signals. The pressure sensing part is coupled to the wireless module, wherein the pressure sensing part comprises at least one pressure sensing unit respectively arranged to generate corresponding pressure sensing signals according to force. The accelerometer is coupled to the wireless module, and arranged to generate acceleration signals according to movement of the pressure sensing device. The computing device comprises a processor, a wireless transceiver module and a storage module. The wireless transceiver module is coupled to the processor and communicably connected to the wireless module, to receive the pressure sensing signal and the acceleration signal from the wireless module. The storage module is coupled to the processor, and arranged to store an application. The camera module is coupled to the processor, and arranged to shoot a video of the pressure sensing device and its surroundings and transmit the video to the processor, wherein the processor executes the application to generate a calculation result according to the video, the pressure sensing signal and the acceleration signal, and the calculation result is used to generate an analysis report for a motion event.

Optionally, according to an embodiment of the present application, each the at least one pressure sensing unit is a impedance pressure sensing membrane, and the impedance pressure sensing membrane comprises a piezoresistive substrate.

Optionally, according to an embodiment of the present application, electrode layers are respectively provided on both sides of the piezoresistive substrate, and an insulation layer is provided on the electrode layer.

Optionally, according to an embodiment of the present application, the electrode layer is a silver paste electrode layer, and the insulation layer is a PET substrate.

Optionally, according to an embodiment of the present application, the pressure sensing device is shaped to be a racket.

Optionally, according to an embodiment of the present application, the racket having a racket face and a grip, the pressure sensing part is arranged on the racket face, and the wireless module and the accelerometer are arranged in the grip.

Optionally, according to an embodiment of the present application, further comprising a rechargeable battery coupled to the accelerometer and the wireless module.

Optionally, according to an embodiment of the present application, the accelerometer is a triaxial acceleration sensor, arranged to generate acceleration data, the acceleration data is used to generate a recognizable gesture.

Optionally, according to an embodiment of the present application, the pressure sensing signal provides batting force data and contact duration data, and the analysis report determines a type of incoming ball according to the batting force data and the contact duration data.

Optionally, according to an embodiment of the present application, the wireless module is universal asynchronous receiver/transmitter (UART).

Optionally, according to an embodiment of the present application, the computing device is a mobile device.

An embodiment of the present invention provides a pressure sensing device shaped to be a racket. The racket has a racket face and a grip, the pressure sensing part is arranged on the racket face, the wireless module and the accelerometer arte arranged in the grip, and the pressure sensing device comprises a wireless module, a pressure sensing part, an accelerometer and a rechargeable battery. The wireless module is arranged to transmit wireless signals. The pressure sensing part is coupled to the wireless module, wherein the pressure sensing part comprises at least one pressure sensing unit respectively arranged to generate corresponding pressure sensing signals according to force. The accelerometer is coupled to the wireless module, and arranged to generate an acceleration signal according to movement of the pressure sensing device. The rechargeable battery is coupled to the accelerometer and the wireless module.

Optionally, according to an embodiment of the present application, each the at least one pressure sensing unit is an impedance pressure sensing membrane, and the impedance pressure sensing membrane comprises a piezoresistive substrate.

Optionally, according to an embodiment of the present application, electrode layers are respectively provided on both sides of the piezoresistive substrate, and an insulation layer is on the electrode layer.

Optionally, according to an embodiment of the present application, the electrode layer is a silver paste electrode layer, and the insulation layer is a PET substrate.

Optionally, according to an embodiment of the present application, the accelerometer is a triaxial acceleration sensor, arranged to generate acceleration data, and the acceleration data is arranged to generate a recognizable gesture.

Optionally, according to an embodiment of the present application, the wireless module is universal asynchronous receiver/transmitter (UART).

In summary, an objective of the present invention is to use three-axis acceleration along with image analysis for posture and motion analysis on the intelligent racket, in which a piezo sensor film is also used to achieve high-speed response, and multiple detections can be performed within a microsecond. In addition, the central area of the racket is specially connected to a high-speed analog-to-digital converter (ADC), and the detection frequency can be up to 2MHz, so that the duration of the strike can be detected more accurately (e.g. in microsecond level). In general, the present invention only uses three-axis acceleration with image analysis for posture and motion analysis, to greatly reduce the complexity of calculations, so that a high-end processing chip is not required. Secondly, the present invention realizes the effectiveness analysis of the spin ball through the high-speed sensing of the racket face, rather than relying on the linear acceleration and angular momentum estimation at the grip, and thus the overall calculation requirements are greatly reduced. In addition, the batting force and contact duration of the spin ball can intuitively provide effectiveness. For example, if the batting force is small but the contact duration is long, it means the degree of “spin ball” is higher; if the batting force is strong while the contact duration is short, it means the degree of “flat batting” is higher.

### BRIEF DESCRIPTION OF THE DRAWINGS

FIG. 1 is a schematic diagram of an intelligent motion analysis system according to an embodiment of the present invention.

FIG. 2 is a schematic diagram of a pressure sensing device according to an embodiment of the present invention.

FIG. 3 is a schematic diagram of the pressure sensing unit in FIG. 2.

FIG. 4 is a schematic diagram of a pressure sensing device according to another embodiment of the present invention.

### DETAILED DESCRIPTION OF THE PREFERRED EMBODIMENT

The present invention is particularly described in the following examples for illustrative purposes only, as those skilled in this art can make various changes and modifications without departing from the spirit and scope of this disclosure, so that the scope of protection of this disclosure should be determined by the appended patent application. Throughout the specification and the scope of patent application, unless the content clearly specifies, the terms “a” and “the” may refer to the meaning of “one” or “at least one” said element or component. In addition, as used in the present invention, the singular term may also include the recitation of plural elements or ingredients unless it is otherwise obvious from a specific context that plural is excluded. Moreover, when applied in this description and in all the following patent applications, the meaning of “in it” may refer to “in it” and “on it” unless the content clearly specifies. Unless otherwise specified, the terms used in the whole specification and patent application scope usually have the ordinary meaning of each term used in this field, in the contents disclosed here and in special contents. Some words used to describe the present invention will be discussed below or elsewhere in this specification to provide additional guidance for practitioner in describing the present invention. The use of examples anywhere in the whole specification, including examples of any words discussed here, is only for illustrative purposes, and certainly does not limit the scope and significance of the invention or any illustrative words. Likewise, the present invention is not limited to the various embodiments set forth in this specification.

The terms “substantially”, “around”, “about” or “approximate” used here should generally mean that the given value or error range is within 20%, preferably within 10%. In addition, the quantities provided here can be approximate, which means that unless otherwise stated, they can be expressed by the words “about”, “about” or “nearly”. When a quantity, concentration or other numerical value or parameter has a specified range, a preferred range or a list of upper and lower ideal values, it shall be deemed as a special disclosure of all ranges formed by any number pairs or ideal values of upper and lower limits, regardless of whether the ranges are disclosed separately. For example, if a certain length of the disclosure range is from x cm to y cm, it should be regarded as the disclosure length of h cm and h can be any real number between x and y.

In addition, if the term “electrical coupling” or “electrical connection” is used, it may include any direct and indirect fashions of electrical connection. For example, if a first device is electrically coupled to a second device, it means that the first device can be directly connected to the second device, or indirectly connected to the second device through other devices or connecting means. In addition, when describing the transmission and supply of electric signals, those familiar with this technology should understand that the transmission of electric signals may be accompanied by attenuation or other non-ideal changes, but unless otherwise specified, the source and receiver of the transmission or supply of electric signals should be regarded as essentially the same signal. For example, if the electrical signal S is transmitted (or provided) from the terminal A of the electronic circuit to the terminal B of the electronic circuit, it may pass through the source and drain terminals of a transistor switch and/or the possible stray capacitance, but the purpose of this design is not to deliberately use the attenuation or other non-ideal changes generated during transmission to achieve some specific technical effects. The electrical signal S should be regarded as substantially the same signal at the terminal A and the terminal B of the electronic circuit.

It can be understood that the terms “including”, “having”, “comprising”, “involving” and so on as used herein are open-ended, which means including but not limited to. In addition, it is not necessary for any embodiment of the invention or the scope of patent application to achieve all the purposes, advantages or features disclosed in this invention. In addition, the Abstract and Title of the invention are only used to assist patent file search, and are not used to limit the scope of the invention.

The technical scheme in the embodiment of the present invention will be described clearly and completely with reference to the attached drawings. Obviously, the described embodiment is only a part of the embodiment of the present invention, but not the whole embodiment. Based on the embodiments in the present invention, all other embodiments obtained by technicians in the field without creative work shall still fall within the scope of protection of the present invention.

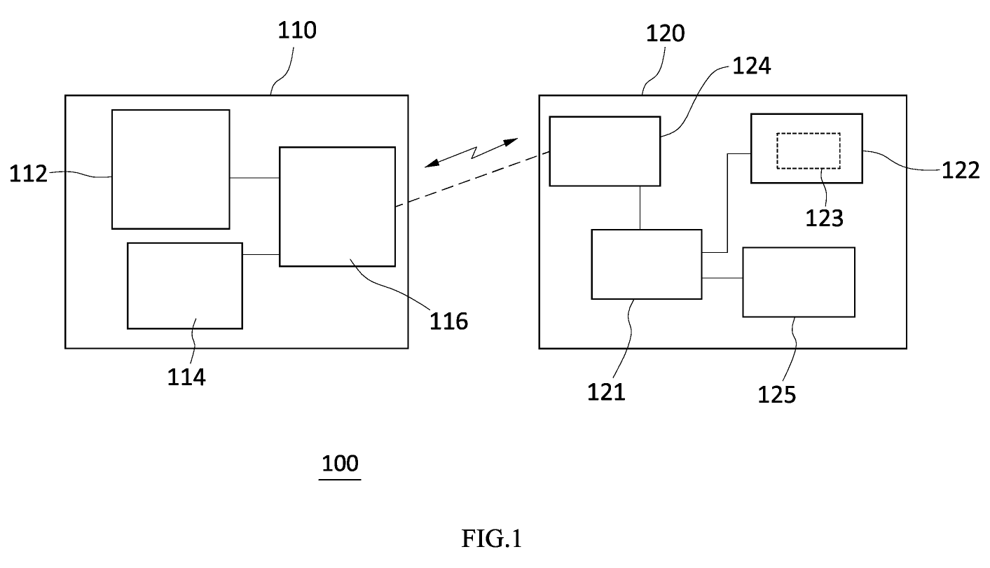

One of the objectives of the present invention is to provide a novel intelligent motion analysis system and related pressure sensing device and intelligent motion analysis method. Please refer to FIG. 1, which is a schematic diagram of an intelligent motion analysis system 100 according to an embodiment of the present invention. As shown in FIG. 1, the intelligent motion analysis system 100 comprises a pressure sensing device 110 and a computing device 120. Please note that in most embodiments, the pressure sensing device 110 is implemented by a racket (such as a table tennis racket, a squash racket, a tennis racket, etc.), and the computing device 120 is implemented by a smart phone, a tablet computer, etc., but the present invention is not limited thereto. The pressure sensing device 110 comprises a wireless module 116, a pressure sensing part 112 and an accelerometer 114. Optionally, the wireless module 116 is a universal asynchronous receiver/transmitter (UART) arranged to transmit a wireless signal. The pressure sensing part 112 is coupled to the wireless module 116, and having at least one pressure sensing unit (not shown) respectively arranged to generate a corresponding pressure sensing signal according to applied force. The accelerometer 114 is coupled to the wireless module 116, and is arranged to generate an acceleration signal according to the action of the pressure sensing device 110. The computing device 120 comprises a processor 121, a wireless transceiver module 124, a storage module 122 and a camera module 125. The wireless transceiver module 124 is coupled to the processor 121 and is communicably connected to the wireless module 116, so as to receive the pressure sensing signal and the acceleration signal from the wireless module 116. The storage module 122 is coupled to the processor 121, and is arranged to store the application camera module 125. The processor 121 is arranged to shoot a video of the pressure sensing device 110 and its surroundings (such as the racket and the ball holder) and transmit the video to the processor 121. The processor 121 executes an application to generate a calculation result according to the video, the pressure sensing signal and the accelerator signal, and the calculation result is arranged to generate an analysis report for a sports event.

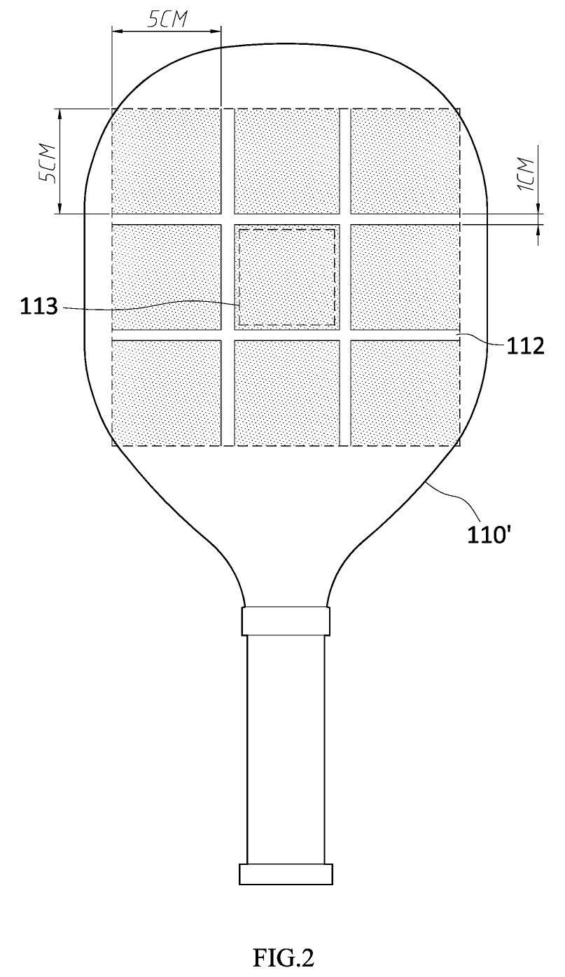

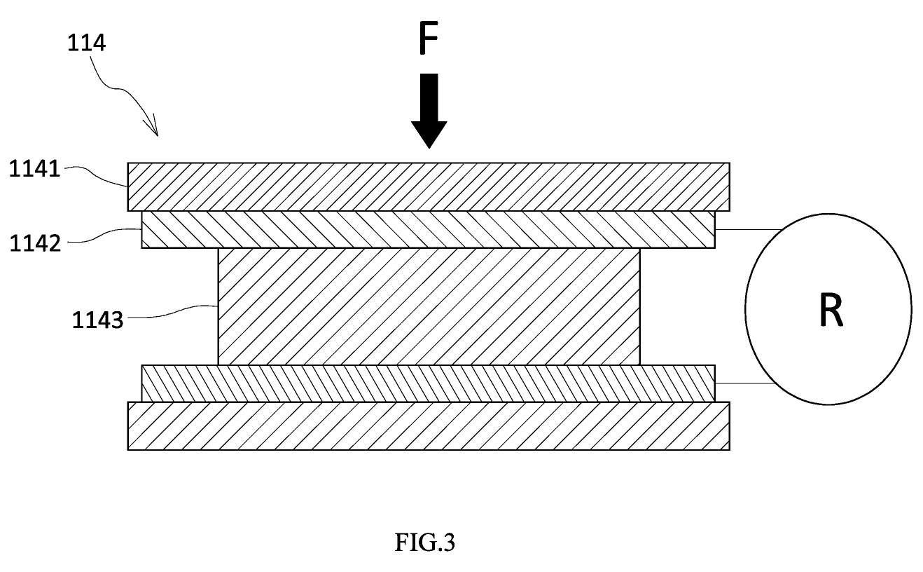

Please refer to FIG. 2, which is a schematic diagram of a pressure sensing device 110' according to an embodiment of the present invention. As shown in FIG. 2, the pressure sensing device 110' is in the shape of a racket (the appearance is a racket with a racket face and a grip), and the pressure sensing device 110' is provided with a pressure sensing part 112. The pressure sensing part 112 is arranged in the racket face, and a wireless module 116 and an accelerometer 114 are arranged in the grip. The pressure sensing part 112 is of a nine-square grid design, and each pressure sensing unit 113 of the pressure sensing part 112 is an impedance pressure sensing membrane (e.g., piezo sensor film), and the impedance pressure sensing membrane comprises a piezoresistive substrate. Electrode layers are respectively provided on both sides of the piezoresistive substrate, and an insulation layer is provided on the electrode layer. Referring to FIG. 3, FIG. 3 is FIG. 2 pressure sensing unit 113, as shown in FIG. 3, the electrode layer is a silver paste electrode layer 1142, the insulation layer is a PET substrate 1141, and a piezoresistive substrate 1143 is provided between the two silver paste electrode layers 1142, and the two silver paste electrode layers 1142 are coupled to a resistor R to generate corresponding resistance values according to the external force F.

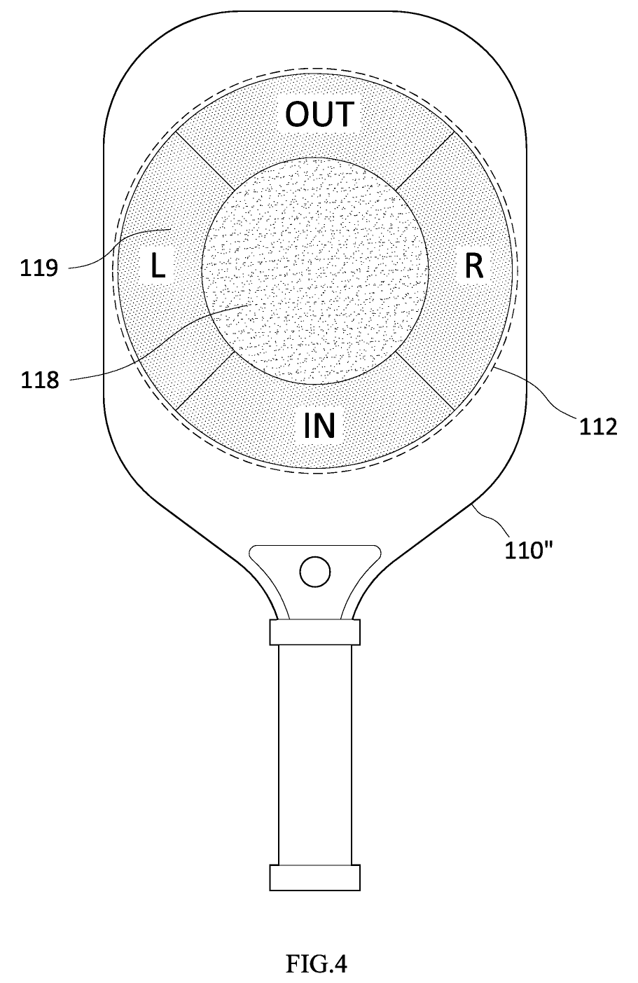

Next refer to FIG. 4, which is a schematic diagram of a pressure sensing device 110'' according to another embodiment of the present invention. As shown in FIG. 4, the pressure sensing part 112 of the pressure sensing device 110'' is of a non-nine-square grid design. Specifically, the pressure sensing part 112 has a central area sensing unit 118 and a plurality of peripheral sector sensing units 119 (four peripheral sector sensing units in this example). The present invention uses three-axis acceleration with image analysis for posture and motion analysis on the smart racket, and a piezoelectric sensing film (piezo sensor film) is also used to achieve high-speed response and multiple detections within a microsecond. In addition, the central area of the racket (such as the above-mentioned central area sensing unit 118) is particularly connected to a high-speed analog-to-digital converter (ADC). The detection frequency can be up to 2 MHz, so that the duration of the hit can be detected more accurately (e.g., microsecond level). In general, the present invention only uses three-axis acceleration with image analysis for posture and motion analysis, which greatly reduces the complexity of calculations, and thus it does not need to carry a high-end processing chip. Secondly, the present invention realizes the effectiveness analysis of spin ball through high-speed sensing of the racket face, rather than relying on the linear acceleration and angular momentum estimation at the grip, which greatly reduces the overall calculation requirements. The batting force and contact duration of the spin ball can intuitively provide effectiveness. For example, if the batting force is small but the contact duration is long, it means that the extent of spin ball is higher; if the batting force is large but the contact duration is short, it means that the extent of flat hit is higher.

Optionally, according to a preferred embodiment of the present invention, the pressure sensing device 110 comprises a rechargeable battery (not shown) coupled to an accelerometer 114 and a wireless module 116. The accelerometer 114 may be a triaxial acceleration sensor, arranged to generate acceleration data, and the acceleration data is arranged to generate a recognizable gesture. However, the present invention does not exclude any other possible alternative. For example, the accelerometer 114 may be a six-axis or nine-axis acceleration sensor. In addition, the pressure sensing signal provides batting force data and contact duration data, and the analysis report is used to determine the type of incoming ball according to the batting force data and contact duration data.

Optionally, according to a preferred embodiment of the present invention, the computing device 120 may be a mobile device and can establish communication with pressure sensing device 110, but a desktop computer or laptop computer is not excluded. For example, computing device 120 may be installed with a corresponding application (APP). The calculation unit 123 is stored in the storage group 122, which may be a deep learning model. The calculation unit 123 is constructed after training with multiple training data, for example, by means of a neural algorithm for training. Specifically, the above training may use Uneo and/or eNeural algorithms. In addition, posture estimation and imaging analysis may use algorithms such as PB Vision and Clutch, which are useful for whole-body movement coordination analysis (including the analysis on trunk position and racket swing, leg coordination, etc.), racket local movement sensing: (including twist, topspin, backspin, etc.).

The processor 121 may include a central processing unit (CPU), or other programmable general-purpose or special-purpose micro control unit (MCU), microprocessor, digital signal processor (DSP), programmable controller, application specific integrated circuit (ASIC), graphics processing unit (GPU), arithmetic logic unit (ALU), complex programmable logic device (CPLD), field programmable gate array (FPGA), or other similar components or combinations of the above components.

In the embodiment a of the present invention, the storage module 122 may be any type of fixed or removable random access memory unit (RAM), read-only memory unit (ROM), flash memory, hard disk drive (HDD), solid state drive (SSD) or other non-volatile memory unit, or similar components, or a combination of the above components.

In summary, the objective of the present invention is to use three-axis acceleration with image analysis to analyze posture and motion on a smart racket, and a piezo sensor film is also used to achieve high-speed response, so that multiple detections can be performed within a microsecond. In addition, the center area of the racket is specially connected to a high-speed analog-to-digital converter (ADC), and the detection frequency can reach 2MHz, so the duration of the hit can be detected more accurately (e.g., microsecond level). In general, the present invention only uses three-axis acceleration with image analysis to analyze posture and motion, which greatly reduces the complexity of calculations, and thus no high-end processing chip is required. Secondly, the present invention realizes the effectiveness analysis of the spin ball through high-speed sensing of the racket face, rather than relying on the linear acceleration and angular momentum estimation at the grip. The overall calculation requirements are greatly reduced. In addition, the batting force and contact duration of the spin ball can intuitively provide effectiveness. For example, if the batting force is little while the contact duration is long, it means the extent of spin ball is higher; if the batting force is strong while the contact duration is short, it means the extent of flat hit is higher.

The embodiments of the present invention are described in detail above. Specific examples are used herein to illustrate the principles and implementation methods of the present invention. The description of the above embodiments is only used to help understand the technical solutions and core ideas of the present invention. A person skilled in the art should understand that the technical solutions described in the above embodiments can still be modified, or some of the technical features can be replaced by equivalents, and these modifications or replacements do not make the essence of the corresponding technical solutions deviate from the scope of the technical solutions of the embodiments of the present invention.

Although the present invention has been described above with the above preferred embodiments, those embodiments are not intended to limit the present invention. As a person skilled in the art may make various changes and modifications without departing from the spirit and scope of the present invention, the scope of the present invention shall be subject to what is defined by the claims.

What is claimed is:

1. An intelligent motion analysis system, comprising:
a pressure sensing device comprising:
a wireless module for transmitting wireless signals;
a pressure sensing part coupled to the wireless module, wherein the pressure sensing part comprises at least one pressure sensing unit respectively arranged to generate corresponding pressure sensing signals according to force; and
an accelerometer, coupled to the wireless module, and arranged to generate acceleration signals according to movement of the pressure sensing device; and
a computing device, comprising:
a processor;
a wireless transceiver module coupled to the processor and communicably connected to the wireless module, to receive the pressure sensing signal and the acceleration signal from the wireless module;
a storage module coupled to the processor, and arranged to store an application; and
a camera module coupled to the processor, and arranged to shoot a video of the pressure sensing device and its surroundings and transmit the video to the processor, wherein the processor executes the application to generate a calculation result according to the video, the pressure sensing signal and the acceleration signal, and the calculation result is used to generate an analysis report for a motion event.

2. The intelligent motion analysis system according to claim 1, wherein each the at least one pressure sensing unit is a impedance pressure sensing membrane, and the impedance pressure sensing membrane comprises a piezoresistive substrate.

3. The intelligent motion analysis system according to claim 2, wherein electrode layers are respectively provided on both sides of the piezoresistive substrate, and an insulation layer is provided on the electrode layer.

4. The intelligent motion analysis system according to claim 3, wherein the electrode layer is a silver paste electrode layer, and the insulation layer is a PET substrate.

5. The intelligent motion analysis system according to claim 1, wherein the pressure sensing device is shaped to be a racket.

6. The intelligent motion analysis system according to claim 5, wherein the racket having a racket face and a grip, the pressure sensing part is arranged on the racket face, and the wireless module and the accelerometer are arranged in the grip.

7. The intelligent motion analysis system according to claim 6, further comprising a rechargeable battery coupled to the accelerometer and the wireless module.

8. The intelligent motion analysis system according to claim 1, wherein the accelerometer is a triaxial acceleration sensor, arranged to generate acceleration data, the acceleration data is used to generate a recognizable gesture.

9. The intelligent motion analysis system according to claim 1, wherein the pressure sensing signal provides batting force data and contact duration data, and the analysis report determines a type of incoming ball according to the batting force data and the contact duration data.

10. The intelligent motion analysis system according to claim 1, wherein the wireless module is universal asynchronous receiver/transmitter (UART).

11. The intelligent motion analysis system according to claim 1, wherein the computing device is a mobile device.

12. A pressure sensing device shaped to be a racket, wherein the racket has a racket face and a grip, the pressure sensing part is arranged on the racket face, the wireless module and the accelerometer arte arranged in the grip, and the pressure sensing device comprises:
a wireless module arranged to transmit wireless signals;
a pressure sensing part coupled to the wireless module, wherein the pressure sensing part comprises at least one pressure sensing unit respectively arranged to generate corresponding pressure sensing signals according to force;
an accelerometer coupled to the wireless module, and arranged to generate an acceleration signal according to movement of the pressure sensing device; and
a rechargeable battery coupled to the accelerometer and the wireless module.

13. The pressure sensing device according to claim 12, wherein each the at least one pressure sensing unit is an impedance pressure sensing membrane, and the impedance pressure sensing membrane comprises a piezoresistive substrate.

14. The pressure sensing device according to claim 13, wherein electrode layers are respectively provided on both sides of the piezoresistive substrate, and an insulation layer is on the electrode layer.

15. The pressure sensing device according to claim 14, wherein the electrode layer is a silver paste electrode layer, and the insulation layer is a PET substrate.

16. The pressure sensing device according to claim 12, wherein the accelerometer is a triaxial acceleration sensor, arranged to generate acceleration data, and the acceleration data is arranged to generate a recognizable gesture.

17. The pressure sensing device according to claim 12, wherein the pressure sensing signal provides batting force data and contact duration data, and the analysis report determines a type of incoming ball according to the batting force data and the contact duration data.
